(19) United States
(12) Patent Application Publication
(10) Pub. No.: US 2018/0225737 A1
(43) Pub. Date: Aug. 9, 2018

(54) Apparatus and System to Facilitate Brick and Mortar Retail business

(71) Applicants: Baldev Krishan, Pleasanton, CA (US); David T. Martini, San Francisco, CA (US)

(72) Inventors: Baldev Krishan, Pleasanton, CA (US); David T. Martini, San Francisco, CA (US)

(73) Assignees: Baldev Krishan, Pleasanton, CA (US); David T. Martini, San Francisco, CA (US)

(21) Appl. No.: 15/423,825

(22) Filed: Feb. 3, 2017

(51) Int. Cl. G06Q 30/06; G06Q 50/00; G06Q 10/08; G06Q 10/10; G06Q 30/02; G06K 7/14; G06K 7/10; G06K 19/06; G06Q 20/12

(52) U.S. Cl. CPC G06Q 30/0623; G06Q 50/01; G06Q 30/0643; G06Q 30/0635; G06Q 10/083; G06Q 20/12; G06Q 30/0276; G06K 7/1417; G06K 7/1095; G06K 19/06037; G06Q 10/107

(57) ABSTRACT

A digital sales system for brick-and-mortar retailers that stores, manages and disseminates product information and enables sales; and an integrated shopping application and social network for shoppers.

### CROSS-REFERENCE TO RELATED APPLICATIONS

This application is a continuation-in-part of pending U.S. patent application Ser. No. 62/388,687 filed 2 May 2016, entitled Apparatus and System to Facilitate Brick and Mortar Retail Business, the content of which is incorporated herein by reference.

### FIELD OF THE INVENTION

The present invention is related to the shopping system and process. More particularly, the present invention is related to the business system and apparatus used in the system including hardware, software and communications for improving business productivity, efficiency and goal achievement and selling of goods.

### BACKGROUND OF THE INVENTION

The Brick and mortar (B&M) business is a type of business that is carried out in any structure or a building. The brick-and-mortar business is usually carried out in retail stores, factory production facilities, or warehouses for its operations. The brick and mortar establishments bring several advantages to the business. One main advantage is the customer service, wherein the customer is attended directly by the personnel present in the shops which is a big plus point in increasing sales of and improving customer satisfaction. The customers can clear their doubts about the products and take the product home with complete satisfaction. Another advantage is the face-to-face interaction wherein the demonstration of the products can be viewed by the customers on spot which increases the confidence in the customers to go for the product.

Nowadays, the brick and mortar business is running in parallel with the online shopping business which is an added advantage to the business. But the problem with the online shopping is that the product which is being purchased by the customer cannot be viewed or checked by the customer while buying. Sometimes the customer may end up receiving faulty product which would be the waste of money and time. Also while buying the products online, as there is no face to face interaction of the customer with the seller, the customer cannot have their questions or doubts about the product being answered on time which leads to slight dissatisfaction in the customers.

A prior art U.S. Pat. No. 6,026,376 discloses an interactive electronic shopping system and method which creates a virtual, shopping facility from an actual shopping facility, such as a grocery store, store, restaurant or office. A shopper at a computer or other suitable display device can move through the virtual shopping facility and see replicas of what would be seen in moving through the actual shopping facility. This invention enables a customer to shop from home, as well as reduce shopping time and ease or enhance the shopping experience. But the main drawbacks of this invention is that it requires a high bandwidth connection to the Internet and the use, of a computer or web based equipment. Additionally, this system requires a person to be located near a computer or area where they have access to the Internet and doesn't allow for the ease of spontaneous, task driven ordering one might expect in a kitchen, which today is often far away from the computer and display device. This invention is limited as only specific vendors would be tied up with the sellers. Also this invention is not economical as investment is high for the equipment and data transfer between the vendor and the consumer across the Internet or other communications network.

Another prior art patent U.S. Pat. No. 6,123,259 discloses an electronic shopping system including customer relocation recognition. This shopping system helps the customers by saving time and money while shopping. Through the use of a hand-held or mounted terminal the system gives consumers directions on where to locate an item in a particular store based on the customer's current location in the store. Additionally, the device displays suggestions on promotional items that the customer may need to replenish. But the device which is provided by a specific retailer, benefits only the retailer interests. Additionally, the cost required for installation of the terminals are high and limited.

None of the above explained prior art inventions provide a system and a method which can solve the problems related to shopping. Some inventions provide high-end solutions which are either customer oriented or seller oriented, but not both.

Hence there is a need for an advanced system and apparatus which not only boosts the retail business but also helps both sellers and customers in various ways to make their shopping experience easier and highly efficient.

### OBJECTIVES OF THE INVENTION

The primary objective of the present invention is to provide an improved system and apparatus for brick and mortar retail business.

Another objective of the present invention is to provide a brick and mortar retail business system which provides a new digital platform for the retailers that efficiently distributes the product information to the shopper's mobile device at a place and time that is convenient to the shopper.

Another objective of the present invention is to provide a brick and mortar retail business system which allows the retailers to customize the products and make them available for the customers looking in their storefront window.

Another objective of the present invention is to provide a brick and mortar retail business system which provides a unique sales platform the retailers and a unique shopping application to the shoppers that expands into a social network.

### SUMMARY OF THE INVENTION

The present invention describes a brick and mortar retail business system and apparatus that ease the business process. The present invention provides a new digital platform that efficiently distributes the product information to the shopper's mobile device at a place and time that is convenient to the shopper.

The present invention connects the brick and mortar retailers with the shoppers and expands the shopping ecosystem both physically and digitally. The system allows the retailers to customize the products and make them available to the shoppers looking in their storefront window. The system also allows the shoppers to capture and act upon this information without going inside the store. The invention provides a unique sales platform and shopping application.

The present invention comprises of a turnkey system for retailers to set up and manage the sales platform and a software application for shoppers to capture and manage product data. The specific components of the present invention includes a product database, a retailer web interface, a QR code transfer software, the means of display, a shopper software, a user account, a social network and a daily report.

The present invention not only provides a system and apparatus for brick and mortar retail business, but also provides a new sales channel for retailers and an efficient way for shoppers to capture and process information about products being displayed in a retail store.

### BRIEF DESCRIPTION OF THE DRAWINGS

FIG. 1 illustrates the schematic representation of the brick and mortar retail business system.

### DESCRIPTION OF INVENTION

The present invention describes a unique apparatus and a system for brick and mortar business that provides a digital platform to distribute the product information to a shopper's mobile device more efficiently. The system allows the retailers to customize the products and enable the customers to view the products just by looking in their storefront window. The customers can capture the product information and decide whether to buy the product or not without going inside the store. The system provides a sales platform along with a shopping application which allows the customers even to share the shopping information on the social network.

The present invention comprises of a turnkey system to set up and manage the sales platform and a software application. The components included in the brick and mortar retail business system includes a database of product information which is delivered as a barcode or QR Code to a standalone LCD display which is attached to a substrate, such as a storefront window, and from there is delivered to a shopper's mobile device where the shopper can manage the product information. In addition to providing a new sales channel for retailers, our Invention provides a new and efficient way for shopper's to capture and process information about products being displayed in a retail store.

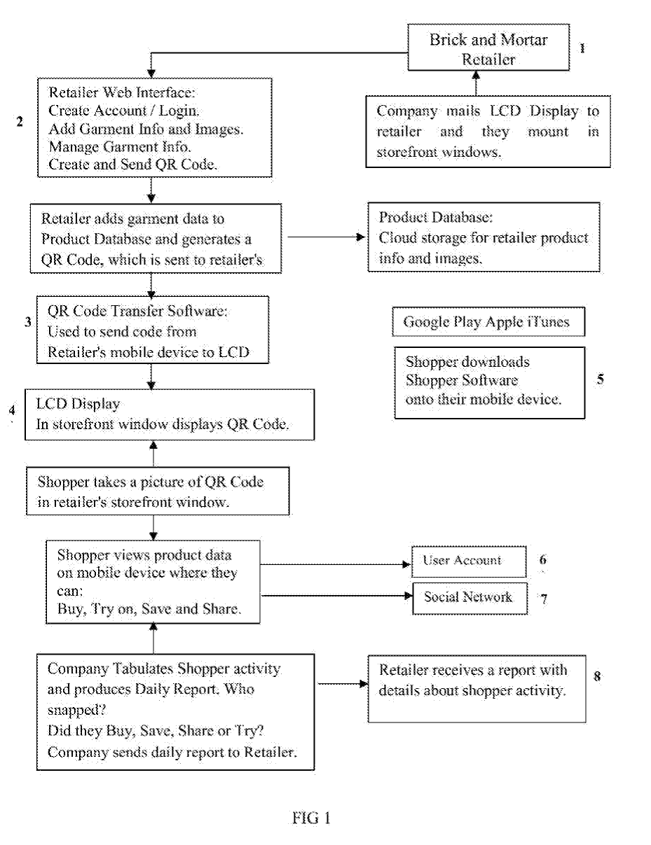

FIG. 1 illustrates the components of the invention, which is described below.

The components of the present invention includes the product database 1, which provides a central location where retailers can to store the text and images of their products. Another component of the present invention is the retailer web interface 2 that allows a retailer to add and manage product content and images, as well as to select a product or a set of products to be represented as a bar code or QR Code. The brick and mortar retail business system produces a code that represents a product or set of products and sends it digitally [via Wi-Fi, Bluetooth, or any other means of communication] to the electronic address specified by the retailer. The QR Code Transfer Software 3 present in the system transfers the QR Code from a mobile device to the LCD Display or any other means of display 4 which includes a unique method for attaching to a substrate. The shopper software 5 of the system enables the shopper to download the product information onto their mobile device and helps to capture and manage product data from any LCD Display in a Retailers storefront window. The shopper/customer can then buy the product or save the product data to their user account 6, and share the garment data with someone in the company's proprietary social network 7 or third party social, network, or try the garment on their personal picture profile, which they uploaded to their user account after signing up for an account. The company tabulates all shopper interactions with specific LCD displays and provides each retailer with a daily report 8 via email.

The Quick Response (QR) code which is a part of the brick and mortar retail business system is highly dynamic and it represents multiple items shown in the storefront window of the retailer. It is automatically updated in the servers' in real time which reflects any changes in the content or images as required by the retailer' and is displayed on the LCD display or any other kind of display. One quick response (QR) code can represent a product or a set of products which is sent by the server to the electronic address of the LCD which represents the retailer show case via WiFi, Bluetooth or any other means of communication.

The shopper software of the present invention captures the shopper downloads onto the mobile device of the shoppers and also manages the product data received from any display means in a retailers' storefront window. The unique ability of the shopper software is that it provides functionality to the shopper that allows the users to save, share, buy or gift any of the products transferred from the QR Code. The shoppers can choose to buy, share, save or gift the products as per their wish. The payment system of the business model allows the shopper to purchase a product directly from the content delivered from the QR Code to their mobile device arid the shipping system allows the shopper to purchase a product directly from the content delivered from the QR Code and have it delivered to a third party address as a gift.

The brick and mortar retail business system has a feature of the user account which is unique for every customer and it has to be created by the user by signing up. The account stores the product information of every products which the user has bought or willing to buy.

Once the user buys the products from airy of the stores, a social network platform can be used to share the product ex. garment data with friends or family or colleagues in the company or any third party or even try the garment on their personal profile picture which the users can upload in their user account.

The daily report which is a component of the brick and mortar retail business is created by the server which contains a tabulated information of all the shopper interactions with specific LCD displays' and is provided to the retailer via email and/or the retailer web interface.

There are several uses and advantages of the present invention. One advantage of the present invention is that the system allows the pedestrians who are walking on a sidewalk to acquire the product information about products being displayed on the storefront window, without having to go inside the store.

Another advantage of the present invention is that the system enables the retailers to extend the sales floor out to the sidewalk so that everyone can easily visualize the product information.

Yet another advantage of the present invention is that it allows the pedestrian to use their mobile devices to take a picture of the LCD display that is affixed inside the retailers store window, which transfers product data about that product or set of products to the pedestrian's mobile device instantly.

Yet another advantage of the present invention includes the ability of a single bar code or QR Code to transfer information about multiple products to the shopper's mobile device.

Yet another advantage of the present invention is that the shopping application allows the retailers to disseminate information about the products in their storefront window when the store is closed. A shopper can capture information and act upon it without having to return to the store the next day. By extending a retailers sales floor to the sidewalk, our system extends a retailers sales hours to 24 hours a day and allows shoppers to get information 24 hours a day.

1. An apparatus and system to facilitate the brick and mortar retail business comprising
a. a product database
b. a retailer web interface
c. a QR code transfer software
d. the means of display
e. a shopper software
f. a user account
g. a social network
h. a daily report

2. An apparatus and system to facilitate the brick and mortar retail business as claimed in claim 1, wherein the product database provides a central location where the retailers can store the text and images of their products.

3. An apparatus and system to facilitate the brick and mortar retail business as claimed in claim 1, wherein the retailer web interface allows a retailer to add and manage the product content and images, as well as to select a product or a set of products to be represented as a bar code or a Quick Response (QR) code.

4. An apparatus and system to facilitate the brick and mortar retail business as claimed in claim 1, wherein the Quick Response (QR) code transfer software is used to transfer a QR Code to the LCD directly from the servers via the internet or other communications medium.

5. An apparatus and system to facilitate the brick and mortar retail business as claimed in claim 4, wherein the Quick Response (QR) code is automatically updated in the servers' in real time which reflects any changes in the content or images as required by the retailers and is displayed on the LCD display or any other kind of display.

6. An apparatus and system to facilitate the brick and mortar retail business as claimed in claim 4, wherein the Quick Response (QR) code is highly dynamic which represents multiple items shown in the storefront window of the retailer.

7. An apparatus and system to facilitate the brick and mortar retail business as claimed in claim 3, wherein the quick response (QR) code represents a product or a set of products which is sent by the server to the electronic address of the LCD which represents the retailer show case is WiFi, Bluetooth or any other means of communication.

8. An apparatus and system to facilitate the brick and mortar retail business as claimed in claim 1, wherein the mode of display is LCD display or any other means of display, which is uniquely attached directly to the inside of the retailers storefront window.

9. An apparatus and system to facilitate the brick and mortar retail business as claimed in claim 1, wherein the mode of display is LCD display or any other means of display.

10. An apparatus and system to facilitate the brick and mortar retail business as claimed in claim 1, wherein the shopper software captures the shopper downloads onto the mobile device of the shoppers and the software also captures and manages the product data from any display means in a retailers' storefront window.

11. An apparatus and system to facilitate the brick and mortar retail business as claimed in claim 10, wherein the shopper software or the application provides functionality to the shopper that allows the users to save, share, buy or gift any of the products transferred from the QR Code i.e. the shopper can perform functions such as buying any of the products transferred from the QR Code; sharing any of the products transferred from the QR Code; saving any of the products transferred from the QR Code; and gifting any of the products bought and transferred from the QR Code.

12. An apparatus and system to facilitate the brick and mortar retail business as claimed in claim 1, wherein the user account has to be created by the user by signing up, which stores the product information which the user has bought or willing to buy.

13. An apparatus and system to facilitate the brick and mortar retail business as claimed in claim 1, wherein the cloud-based system allows a shopper to set up a payment system and associated shipping system in advance of using the shopper software or application.

14. An apparatus and system to facilitate the brick and mortar retail business as claimed in claim 1, wherein the social network platform can be used to share the garment data with some in the company or a third party or try the garment on their personal profile picture which the users can upload in their user account.

15. An apparatus and system to facilitate the brick and mortar retail business as claimed in claim 1, wherein the daily report is created by the server which contains a tabulated information of all the shopper interactions with specific LCD displays' and is provided to the retailer via email and/or the retailer web interface.

16. An apparatus and system to facilitate the brick and mortar retail business as claimed in claim 12, wherein the payment system allows a shopper to purchase a product directly from the content delivered from the QR Code to their mobile device and the associated shipping system allows the shopper to purchase a product directly from the content delivered from the QR Code and automatically have it delivered to a third party address as a gift.

17. An apparatus and system to facilitate the brick and mortar retail business as claimed in claim 1, wherein the daily report is created by the company which contains a tabulated information of all the shopper interactions with specific LCD displays.

18. An apparatus and system to facilitate the brick and mortar retail business as claimed in claim 1, wherein the system allows the retailers to customize and present the product bundles and make them available to shoppers looking in their storefront window, without going inside the store.

19. An apparatus and system to facilitate the brick and mortar retail business as claimed in claim 1, wherein the apparatus allows the retailers to extend the sales floor out to the sidewalk.

20. An apparatus and system to facilitate the brick and mortar retail business as claimed in claim 4, wherein a single QR code or a barcode has the ability to transfer the information about multiple products to the shoppers' mobile device.

21. An apparatus and system to facilitate the brick and mortar retail business as claimed in claim 1, wherein the system allows the retailers to disseminate information about products in their storefront window even when the store is closed which enables the shoppers to capture the information 24/7 and act upon it.
